(19) United States
(12) Patent Application Publication
(10) Pub. No.: US 2005/0202864 A1
(43) Pub. Date: Sep. 15, 2005

(54) Wagering game method and apparatus involving skill

(76) Inventors: Gerard Duhamel, Drummondville (CA); Martin Roy, Drummondville (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/103,634

(22) Filed: Apr. 12, 2005

Related U.S. Application Data
(63) Continuation of application No. PCT/CA03/01615, filed on Oct. 29, 2003.
(60) Provisional application No. 60/421,733, filed on Oct. 29, 2002.

(51) Int. Cl. A63F 13/00

(52) U.S. Cl. 463/16

(57) ABSTRACT

A game method requiring skill from the players and involves a display on a gaming terminal screen of the game that comprises a model image representation and a game board wherein a plurality of moving objects are displayed. The objects comprise portions of said model image and at least one portion of an alien image. To play, the player selects at least one object. Upon selection, the gaming terminal identifies each object as from the model image or from an alien image. If one selected object is a portion of an alien image, the game ends. However, if all the selected objects are portions of the model image, these objects are removed from the group of moving objects on the game board. When all objects that are portions of the model image have been selected, the play is determined a win.

### Related Patent Application

This application is a continuation of PCT patent application serial number PCT/CA2003/001615 filed Oct. 29, 2003, now pending, which claims priority from U.S. provisional patent application Ser. No. 60/421,733 filed Oct. 29, 2002, now abandoned, the specifications of which are hereby incorporated by reference.

### FIELD OF THE INVENTION

The invention relates to a new method of providing an outcome in a wagering game.

### BACKGROUND

Wagering games are well known. They are divided in many categories (poker, bingo, line games, etc.) and played on different media (on gaming tables with cards or tiles, on gaming terminals, on cell phones, etc.). They are also divided into two major categories: games of chance and games of skills. To play these games in an electronic format, players put credits into their gaming terminals, place bets and are awarded prizes based on the outcomes obtained during the game play.

To attract new players, game designers continually create new games, features and ways to provide these outcomes to the players.

A known solution to incite players to play longer on these gaming terminals is to give them more control. This control may even create challenges for the players, with the player incentive partly residing in having the possibility to improve their performance and, sometimes, to increase the prizes.

The present invention relates to many fields: puzzle, skill, competition and prize awarding games.

There are many kinds of electronic puzzle games. One of these is known as a “water-pipeline game” wherein a figure is to be completed by connecting lines. Another one is played on the “Puzzle Game Apparatus” of the U.S. Pat. No. 6,398,641. These two games provide challenges to players based on the positioning of tiles.

Another puzzle game offering challenges to players is described in the U.S. Pat. No. 6,602,133 entitled “Interactive electronic puzzle game . . . ”, which allows the player a limited time to perform a specific action in the puzzle. When the player does not complete said action within the allotted time, the puzzle is rearranged.

Other games and features have been developed; examples of developments applied to wagering games and gaming terminals are players driving a virtual car during a race in a bonus mode, answering trivia questions in order to be awarded bonus prizes, selecting objects of hidden values in a second-screen bonus, traveling through a path on a Monopoly game board, etc.

There is always a need for new methods or apparatuses to increase the player's interest in wagering games. In consequence, improvement in the field of wagering games is still required.

### SUMMARY OF THE INVENTION

In consequence, the invention consists in a game played on a gaming terminal, a player terminal or system suitable for the play of said game and a method of playing said game.

The invention method of playing the game involves displaying a representation of the game on a gaming terminal screen; said game representation comprises a model image representation and a game board wherein at least one (but usually a plurality) of moving objects are displayed. The objects comprise portions of said model image and at least one portion of an alien image. To play, the player selects objects. Upon selection, the gaming terminal identifies the objects as from the model image or from an alien image. If one selected object is a part of an alien image, the play ends. However, if the selected object is part of the model image, this object is removed from the moving objects on the game board. When all objects from the model image have been selected, the play is established as a win.

The above method can also be applied in game environments wherein many players compete against each other and each player is being given at least one model image. During the play, selected objects are distributed randomly to players that select objects they judge part of their model image. A play ends when the player has selected a wrong object, such as a portion of another player's model image. The winner is the player succeeding to select all objects part of his model image, or the last player remaining.

A specific embodiment is a method of playing a bingo game on linked gaming terminals. Accordingly, players select representation of bingo numbers on their terminals in order to be the first to create a winning pattern on their bingo card.

The method of the invention includes additional characteristics as disclosed in the following descriptions and embodiments of the invention as well as in the annexed claims. Such characteristics include the prize awarding to players and game playing until a loss. Other disclosed characteristics relate to the selection of the objects, the determination of the value of the prize awarded, the game environment, etc.

The invention also includes a suitable environment for the play of the game. Such an environment comprises gaming terminals to play the game in individual mode and a more complex gaming system with many components for competition mode.

A gaming terminal for the individual mode comprises credit-related means, input means, display means, a memory and computing means. The computing means are arranged (a) to interpret software code from the memory, (b) to exchange information with the credit-related means and the input means, (c) to control the display means to provide a representation of the game, and (d) to modify process of the game in accordance with information received from the input means; therefore, the computing means end the game as a wrong selection is completed by the player.

A gaming system for playing the game in a competition mode comprises a central system, a communication means, and gaming terminals. The central system provides objects to the gaming terminals, which display them in a synchronous manner. The players select objects on their terminals in accordance with the method of playing the game until a winner is established.

A method of playing a game on a gaming terminal comprising displaying a game representation on an electronic display; receiving selection inputs from a player for the selection of objects within said game representation; and establishing a game status upon achieving a final state in the game; displaying within the game representation a model image and a game board for displaying at least one of said objects, said object being selected among a population of objects representing portions of said model image and portions of an alien image; removing representation of said selected object from the game representation; establishing a loss game status upon selection of an object representing said portion of said alien image; and establishing a win game status upon selection of all objects required to fulfill a win criterion.

A method of playing a wagering game comprising registering a plurality of players on linked gaming terminals for the play of the game; dispensing a model image to each of said players; providing randomly selected objects to display to all gaming terminals; and establishing a player as a winner when one of:—the participation of all other registered players' model images in the play of the game has ended, and—said player has successfully selected all objects fulfilling a winning criterion in view of his model image; displaying a game representation on each player's gaming terminal, said game representation comprising the player's model image representation and a game board wherein, during the play of the game, at least one of said randomly selected object is displayed; receiving selection inputs from players, said selection inputs corresponding to selection of at least one said objects; identifying each of the at least one selected object as from the selecting player's at least one model image; and ending participation in the play of the game of at least one of the plurality of player's model image upon a negative identification of at least one of the at least one selected object.

A method of playing a bingo game on gaming terminals comprising: receiving bets from a plurality of players; dispensing a bingo card bearing numbers to each of said players; completing a random draw of bingo numbers on a central system; transmitting the drawn bingo numbers to the gaming terminals; marking matches between one of said drawn bingo numbers and a card-borne number of a player's bingo card; establishing a winner when the markings of a player's bingo card fulfills a win criterion; and awarding said winner a prize; synchronously displaying a representation of received bingo numbers on each player's gaming terminal; receiving selection inputs of said drawn bingo number from players through selection of their representations; evaluating each of the drawn bingo numbers as to whether or not it matches at least one card-borne number of the player's bingo card; ending participation of a player's bingo card upon a negative evaluation of a selected bingo number.

A gaming terminal for the play of a game, comprising credit-related means; input means; display means; memory; and computing means arranged to interpret software code from memory, to receive input commands from the input means, and to receive inputs from and to authorize actions of credit-related means, and to control images on the display means in a manner of providing a representation of the game comprising at least one model image and a game board wherein at least one object is displayed; the display means providing a representation of randomly selected objects among a group of objects representing a portion of a model image and a portion of an alien image; the input means receiving selection inputs from players, said selection inputs corresponding to the election of displayed objects; the computing means identifying each of the elected objects as being from the model image; and the computing means ending participation in the play of the game of at least one model image upon a negative identification of an elected object.

A gaming system for the play of a game among a group of players, comprising a central system; communication means; and a group of gaming terminals in communication with the central system through the communication means, each gaming terminal comprising credit-related means, input means, display means, memory, and computing means arranged to interpret software code from memory, to receive input commands from the input means, and to receive inputs from and to authorize actions of credit-related means, and to control images on the display means in a manner of providing a representation of the game comprising a model image and a game board wherein for displaying at least one object; the central system providing randomly selected objects among a group of objects from said model image and synchronously transmitting the selected objects to the gaming terminals; the gaming terminals: receiving selection inputs from players, said selection inputs corresponding to the election of at least one displayed object; identifying each of the at least one elected object as being from the selecting player's at least one model image; and ending participation in the play of the game of at least one selecting player's model image upon a negative identification of an elected object.

### BRIEF DESCRIPTION OF THE DRAWINGS

These as well as other aspects and advantages of the invention will become easier to understand in light of the following description and embodiments of the invention and in reference to the accompanying drawings, in which:

FIG. 1 is a schematic illustration of a gaming terminal suitable for the play of the game of the invention;

FIG. 2 is a schematic representation of a play screen suitable for the play of the game of the invention;

FIG. 3 is a flow chart illustrating steps of playing the game of the invention in an individual manner;

FIG. 4 is a flow chart illustrating steps of playing the game of the invention in a competitive manner among players; and

FIG. 5 is a schematic illustration of a suitable system for the latter embodiment of the invention.

### DETAILED DESCRIPTION OF THE INVENTION

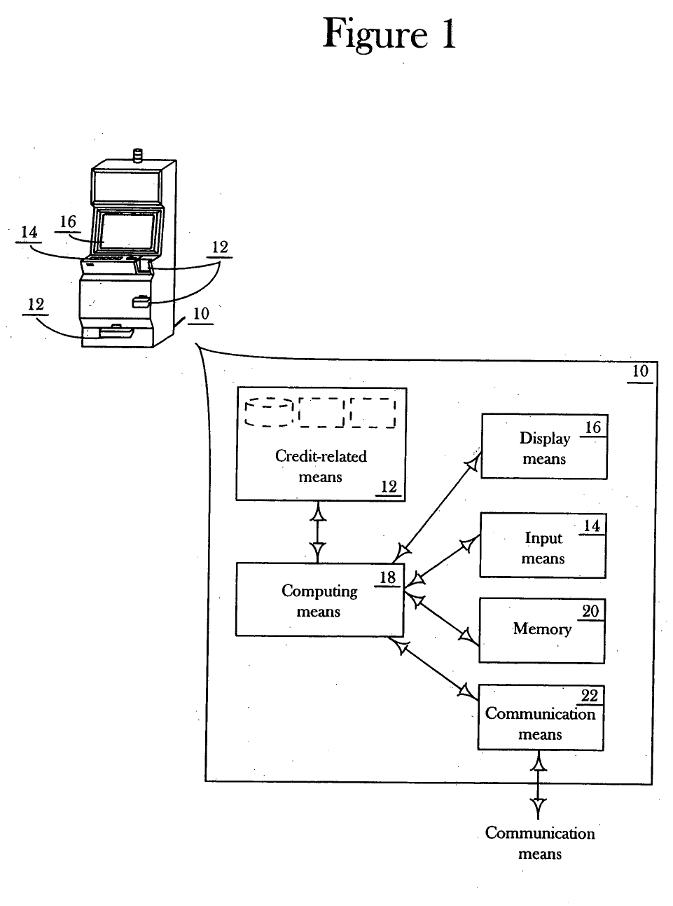

FIG. 1 illustrates a suitable gaming terminal 10 for the play of the game of the invention. Such a gaming terminal 10 comprises credit-related means 12 for the reception of bets, the monitoring of the bets and the wins, and the win redemption to the player. It also comprises a series of player input means 14 to provide the gaming terminal with every information required for the play, such as the bet selection, the actuation of the game, and a redemption command. The gaming terminal 10 also comprises a game display 16, said display 16 providing a representation of the game during its play, and all other information required to play the game. Finally, the gaming terminal comprises at least computing means 18 and memory 20 in which software code is stored, the computing means processing all information provided by the gaming terminal components in order to complete the play of the game to its final outcome.

Devices fulfilling the above characteristics of a gaming terminal may include electronic gaming apparatuses, personal computers, cell phones, or any electronic devices that include suitable components for the play of the present invention.

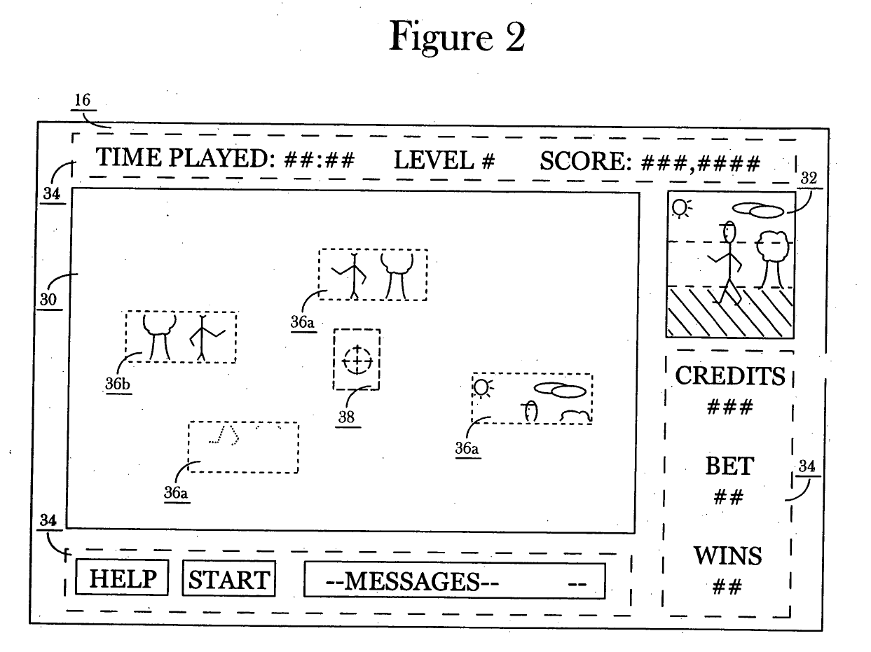

FIG. 2 illustrates a typical representation of the game on the gaming terminal display 16. The game representation includes basically two but ideally three regions: a game board 30, a model image representation 32, and the third and optional region providing game-related information 34. The game-related information 34 includes all information required for the play of the game, but that is not part of the game itself, for example, images and messages informing on touch screen controls, betting information, play time, etc. The model image representation 32 is the model image with information on selection status of the image corresponding objects. Finally, the game board 30 is a display area 16 wherein objects 36 are in motion, waiting for a player selection.

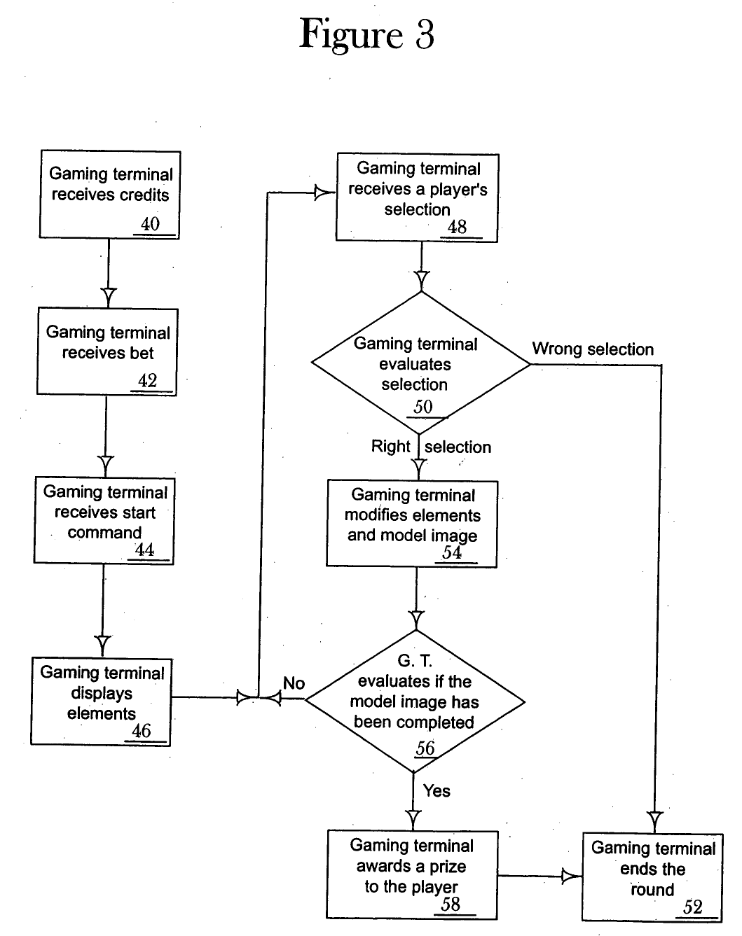

The typical steps to play the game are as illustrates on FIG. 3. The player inserts credits (step 40), or credit information, in his gaming terminal 10. He uses these credits to finance bets (step 42). Afterwards, the player starts the game (step 44). At this time, appear objects (step 46) (also called parts or portions of images) on the game board. Among these objects 36 are portions of the player's model image 36a that makes up a complete model image and at least one portion 36b of an image that differs from the model image (hereinafter called alien image). The goal of the player is to try to identify the right objects and to select them (step 48), the selected object being automatically evaluated (step 50). If the player does a wrong selection (a portion of an alien image), the play ends (step 52). However, if the player selection is a right one (genuine portion), the object disappears (step 54) from the game board and the model image representation is modified (also step 54) in consequence. This process repeats itself until the player has selected all the right objects (step 56) or a wrong one (step 50). When all right objects are selected, the player wins and is awarded a prize (step 58).

Many variations of this typical process for playing the game are available. For instance, the play may continue for at least one other round with an increased difficulty level following a successful play. In this context, the prize may be awarded when the player loses, or when the player has successfully completed the top level.

Another variation may reside in the way the objects are selected. In the case of the game representation illustrated on FIG. 2, the player may use touch screen controls to select objects. A variation is to provide the player with a selection window 38 displayed within the game board. When an object is over or under the selection window, the player may press a selection control to select this object. The player can even select many objects at once. Other ways of selecting objects are also available, such as replacing the selection window by a selection aiming mean, a target cross for example.

To control the difficulty level of the game, the number of objects constituting the model image may vary. The model image may comprise holes, the holes being the objects that must be selected to succeed. Another possibility is to vary the number of objects coming from alien images. Another possibility is to vary the speed of the objects in motion, to place the selection window in motion, to vary the speed of the components in motion. Yet, other possibilities are to limit the selection life span of the objects, to limit the time to complete the play, etc. Another possibility is to render the identification of the model image corresponding objects less evident through a modification of the model image representation (for instance, fade-out, black-and-white versus color images, or blinking image), or though similar modifications of the object representations. Etc.

Another variation of the described process is to provide a timer (counter) to monitor the time played. In addition, a point counter may add up cumulated points as the game progresses, these points being awarded as object selections are completed. Accordingly, the awarded prize value may be calculated based on cumulated points, the time used to end the game, or a combination of these methods.

The game described may be played as a primary game. Accordingly, the player places the bet to play the current game up to its outcome and is rewarded accordingly. The game may also be configured as a bonus game. When a trigger event in an underlying game occurs, the game switches to a representation of the invention game. Said game is played up to its outcome and a bonus prize is awarded accordingly. Another alternative is to provide the game as an optional game. The player participates in an underlying game and a counter cumulates the wins. At some point, the player is offered to play the current optional game, if the player accepts, this player can place at least part of his wins as a bet in the optional game. In consequence, the game cannot be played directly with credits inserted by the player but only with winning credits provided by previous plays of the underlying game.

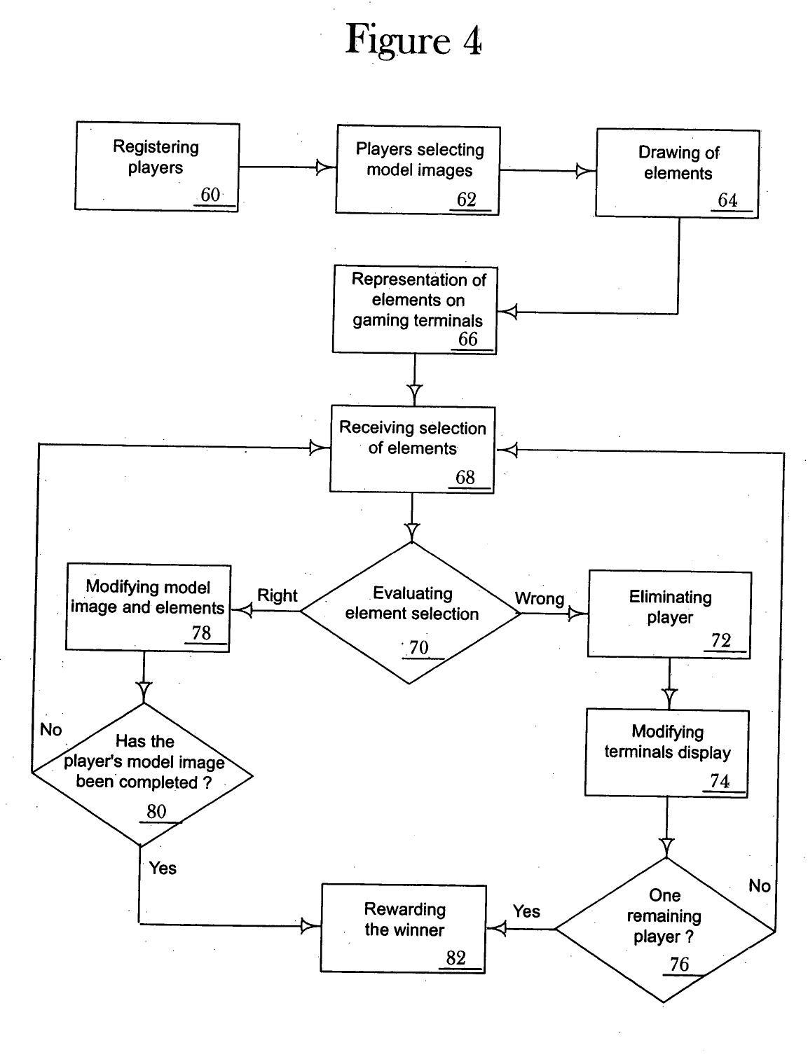

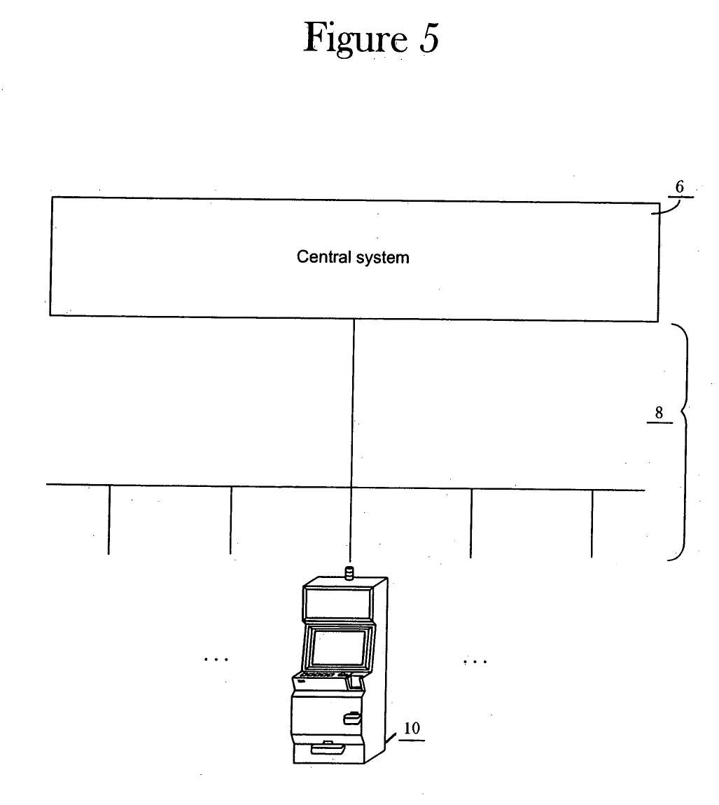

The competition game (FIG. 4) is another variation if played in a suitable environment (FIG. 5) that includes a plurality of linked gaming terminals 10. For this embodiment, the players register to play this game and are offered to select a model image. When a predetermined number of players (five [5] for the present example) have registered (step 60) and selected a model image (step 62), the play begins. A central system 6, linked to the gaming terminals 10 through communication means 8, draws the objects (step 64), and sends them to the five gaming terminals. As the gaming terminals 10 receive the objects, they display them synchronously (step 66) on their respective game board 10. The players try to identify and to select the objects (step 68) part of their model image. The selected objects are evaluated (step 70). When a player selects correctly an object, the model image representation of the player is modified (step 78). Furthermore, the object is removed (step 78) from the game board of all the gaming terminals 10. However, when a player selects a wrong object, the player is eliminated (step 72) of the play; i.e., he loses. The objects that are part of the eliminated player's model image are removed (step 74) from the game board of all remaining active gaming terminals. The play continues until only one of the five [5] original players remains active (step 76), or until a player completes his or her model image (step 80) by selecting all objects of said image. This player is established as the winner and is awarded (step 82) a prize.

This embodiment, as in a previously described embodiment, may include many variations. The competition game may also include some of the variations and/or characteristics that are listed above for any previously described embodiments. For instance, the objects of alien images (such as other player's model images) or all objects may have a selection time limit. When this life span is elapsed, the objects may automatically disappear from the game board of all gaming terminals 10.

A particular embodiment of the competition game version is for playing a bingo game. Players are dispensed game cards bearing nine [9] numbers for instance. The central system draws ball numbers and sends them to the gaming terminals. The players select them as soon as they appear on the player terminal screen without selecting wrong numbers. The first player that creates a straight line of three [3] numbers by marking his or her bingo card with the selected numbers or the last player who remains active is established the winner. The prize value awarded to the winner may be based on the winner performance.

Many parameters may take place in the calculation of the winning prize value. The prize value may be predetermined. It may depend on the reached game level or the difficulty level of the last play. A prize may be awarded for each right selection. Extra awards may be given for completion of a model image. The prize value may be randomly determined on a lottery system with predetermined values, by comparing a game score with a lottery result, by comparing a game score with a pay schedule, etc.

Accordingly, while the invention has been described in connection with the specific embodiments thereof and their disclosed variations, it will be understood that other modifications are available. It is the intent to cover any variations, uses, or adaptations of the invention following, in general, the principles of the invention. Such covered applications will find their essential features herein set forth in the scope of the appended claims.

1. A method of playing a game on a gaming terminal comprising:
displaying a game representation on an electronic display;
receiving selection inputs from a player for the selection of objects within said game representation;
establishing a game status upon achieving a final state in the game;
displaying within the game representation a model image and a game board for displaying at least one of said objects, said object being selected among a population of objects representing portions of said model image and portions of an alien image;
removing representation of said selected object from the game representation;
establishing a loss game status upon selection of an object representing said portion of said alien image; and
establishing a win game status upon selection of all objects required to fulfill a win criterion.

2. The method of claim 1, wherein said objects are in motion.

3. The method of claim 1, wherein said win criterion comprises a selection of all objects from at least one of said at least one model image.

4. The method of claim 1, further comprising progressively adding new objects to include in game representation.

5. The method of claim 1, further comprising awarding a prize to said player for a win.

6. The method of claim 1, further comprising setting a difficulty level through at least one of:
the number of objects that are from alien images;
the number of objects that are from the at least one model image;
the speed of the objects in motion;
a limited object life span for their selection;
a modified view of said model image; and
a modified view of the objects in motion.

7. The method of claim 6, wherein said setting ok difficulty level through a modified view of the objects or of the model image comprises fading out said objects or said model image.

8. The method of claim 6, wherein said setting a difficulty level through a modified view of the model image comprises at least one of:
providing a view of the whole model image only before the beginning of the play; and
providing a view the model image for at least one short period of time.

9. The method of claim 6, wherein the speed of the moving objects is at least one of constant and homogenous.

10. The method of claim 6, further comprising setting increasing difficulty levels as the play progress.

11. The method of claim 1, wherein said selection input is completed through one of:
a player's selection on a touch screen control; and
player actuation of a control in regard with a selection window.

12. The method of claim 11, wherein said selection window takes form of an aiming means.

13. The method of claim 1, comprising modifying the representation of at least one model image upon selection of objects.

14. The method of claim 1, further comprising identifying time spent by the player to play the game as said play progress.

15. The method of claim 1, further comprising awarding points as the player selects objects.

16. The method of claim 1, wherein said game comprises at least one of:
a primary game;
a bonus game;
an optional game; and
a competition game.

17. The method of claim 1, further comprising to link at least two gaming terminals for the play of said game with a player playing on each gaming terminal.

18. A method of playing a wagering game comprising:
registering a plurality of players on linked gaming terminals for the play of the game;
dispensing a model image to each of said players;
providing randomly selected objects to display to all gaming terminals; and
establishing a player as a winner when one of:—the participation of all other registered players' model images in the play of the game has ended, and—said player has successfully selected all objects fulfilling a winning criterion in view of his model image;
displaying a game representation on each player's gaming terminal, said game representation comprising the player's model image representation and a game board wherein, during the play of the game, at least one of said randomly selected object is displayed;
receiving selection inputs from players, said selection inputs corresponding to selection of at least one said objects;
identifying each of the at least one selected object as from the selecting player's at least one model image; and
ending participation in the play of the game of at least one of the plurality of player's model image upon a negative identification of at least one of the at least one selected object.

19. The method of claim 18, wherein said at least one object is in motion.

20. The method of claim 18, wherein fulfilling said winning criterion comprises selecting all objects from said model image.

21. The method of claim 18, further comprising removing representation of a selected object among said moving objects on at least one gaming terminal.

22. The method of claim 21, comprising:
identifying the selecting gaming terminal receiving the selection input identifying the selected object; and
removing the representation of said selected object of the identified gaming terminal.

23. The method of claim 21, comprising removing the representation of said selected object among the moving objects on all gaming terminals.

24. The method of claim 18, further comprising awarding a prize to the winner.

25. The method of claim 18, further comprising monitoring dispensed model images in order to prevent duplicate objects on dispensed model images.

26. The method of claim 18, comprising completing a random selection of objects to display on gaming terminals among a predetermined population of objects.

27. The method of claim 18, further comprising associating to objects a limited life span, which, once elapsed, results in removing the representation of said objects on the gaming terminals.

28. The method of claim 24, comprising calculating the prize value based on at least one of a random determination through a lottery-like draw, a random determination trough comparison with a randomly-drawn value, and a comparison of at least one parameter cumulated during the play with a pay schedule.

29. The method of claim 27, comprising:
monitoring participation status of players' model images in order to identify a last remaining player; and
removing representation of all moving objects on the last remaining player's gaming terminal that are not from a last player's model image.

30. The method of claim 18, further comprising displaying the evolution of completion of a model image as objects from said model image are selected.

31. The method of claim 18, wherein model images are bingo cards and objects are numbers, and wherein a number borne by a bingo card is identified as from said bingo card.

32. The method of claim 18 played in a game environment comprising a plurality of gaming terminals, a central system, and communication means linking game environment components.

33. A method of playing a bingo game on gaming terminals comprising:
receiving bets from a plurality of players;
dispensing a bingo card bearing numbers to each of said players;
completing a random draw of bingo numbers on a central system;
transmitting the drawn bingo numbers to the gaming terminals;
marking matches between one of said drawn bingo numbers and a card-borne number of a player's bingo card;
establishing a winner when the markings of a player's bingo card fulfills a win criterion; and
awarding said winner a prize;
synchronously displaying a representation of received bingo numbers on each player's gaming terminal;
receiving selection inputs of said drawn bingo number from players through selection of their representations;
evaluating each of the drawn bingo numbers as to whether or not it matches at least one card-borne number of the player's bingo card; and
ending participation of a player's bingo card upon a negative evaluation of a selected bingo number.

34. The method of claim 33, further comprising:
identifying the selecting gaming terminal receiving the selection input; and
removing the representation of the selected number of the identified gaming terminal.

35. The method of claim 33, further comprising:
monitoring participation status of players' bingo cards in order to identify a last remaining player;
signaling this state on at least the gaming terminal of the last remaining player.

36. The method of claim 36, further comprising removing the representation of all bingo numbers that do no match any card-borne numbers of the participating bingo cards of the last remaining player.

37. The method of claim 33, wherein fulfilling a win criterion comprises having the markings of a bingo card to correspond to a predetermined pattern.

38. The method of claim 33, further comprising associating the representation of a bingo number with a limited life span, which, once elapsed, results in the removing of the representation of said bingo number on the gaming terminals.

39. A gaming terminal for the play of a game, comprising:
credit-related means;
input means;
display means;
memory; and
computing means arranged to interpret software code from memory, to receive input commands from the input means, and to receive inputs from and to authorize actions of credit-related means, and to control images on the display means in a manner of providing a representation of the game comprising at least one model image and a game board wherein at least one object is displayed;
the display means providing a representation of randomly selected objects among a group of objects representing a portion of a model image and a portion of an alien image;
the input means receiving selection inputs from players, said selection inputs corresponding to the election of displayed objects;
the computing means identifying each of the elected objects as being from the model image; and
the computing means ending participation in the play of the game of at least one model image upon a negative identification of an elected object.

40. The gaming terminal of claim 39, further wherein the display means provides representation of said objects in motion.

41. The gaming terminal of claim 39, further wherein the computing means comparing the elected objects with the at least one model image and establishing the player as a winner when said player has elected the objects required to fulfill a winning criterion.

42. The gaming terminal of claim 39, further wherein the computing means commanding representation of new objects on the display means as the play progresses.

43. The gaming terminal of claim 41, further wherein the credit-related means providing a prize to said winner.

44. The gaming terminal of claim 40, further wherein the computing means setting a difficulty level by at least one of:
controlling the number of displayed objects from an alien image;
controlling the number of objects in which a model image is divided in;
controlling the speed of objects in motion;
providing a limited life span to objects;
modifying the representation on the display means of a model; and
modifying the representation on the display means of objects.

45. The gaming terminal of claim 40, further wherein the display means providing a representation of objects in a constant and homogenous motion.

46. The gaming terminal of claim 44, further wherein the computing means modifying the difficulty level as the play of the game progresses.

47. The gaming terminal of claim 39, wherein said input means comprise at least one of:
a touch screen control; and
an electromechanical control used in accordance with a characteristic of the representation of an object on the display means, wherein said input means is used to elect at least one displayed object.

48. The gaming terminal of claim 39, further wherein the computing means modifying representation of at least one of:
the displayed objects; and
at least one of the at least one model image upon election of an object.

49. The gaming terminal of claim 39, further wherein the memory comprising counter means, with value in said counter means being modified in accordance with the progress of the game.

50. The gaming terminal of claim 39, further wherein the computing means switching game representation on the display means in accordance with a result in an underlying game.

51. The gaming terminal of claim 39, further wherein the gaming terminal comprising communication means to communicate with other gaming terminals and with a central system, which central system completes a random selection of objects, transmits the objects to the gaming terminals, and the computing means of the gaming terminals control their display means to provide a representation of the objects on their display means in a synchronous manner.

52. A gaming system for the play of a game among a group of players, comprising:
a central system;
communication means; and
a group of gaming terminals in communication with the central system through the communication means, each gaming terminal comprising credit-related means, input means, display means, memory, and computing means arranged to interpret software code from memory, to receive input commands from the input means, and to receive inputs from and to authorize actions of credit-related means, and to control images on the display means in a manner of providing a representation of the game comprising a model image and a game board wherein for displaying at least one object;
the central system providing randomly selected objects among a group of objects from said model image and synchronously transmitting the selected objects to the gaming terminals;
the gaming terminals:
receiving selection inputs from players, said selection inputs corresponding to the election of at least one displayed object;
identifying each of the at least one elected object as being from the selecting player's at least one model image; and
ending participation in the play of the game of at least one selecting player's model image upon a negative identification of an elected object.

53. The gaming system of claim 52, further wherein the computing means of the gaming terminals comparing each player's elected objects with said player's at least one model image and establishing a player as a winner when said player has elected the objects required to fulfill a winning criterion.

54. The gaming system of claim 52, further wherein the computing means of the gaming terminals removing representations of objects on the display means as said objects are elected by players.

55. The gaming system of claim 53, further wherein the computing means authorizing the awarding of a prize to the winner.

56. The gaming system of claim 52, further wherein the central system monitoring model images on gaming terminals and preventing duplicate information on model images.

57. The gaming system of claim 52, further wherein the computing means of the gaming terminals associating a life span to a displayed object, and removing representation of said object when the life span of the object as elapsed.

58. The gaming system of claim 52, further wherein the central system monitoring participation status of player's model images in order to identify a last remaining player; and at least one of:
the computing means of the last player's gaming terminal removing representation of all displayed objects that are not part of the last player's model images; and
the computing means of the last player's gaming terminal establishing said player as a winner.
